(19) United States
(12) Patent Application Publication
(10) Pub. No.: US 2007/0114752 A1
(43) Pub. Date: May 24, 2007

(54) Method of making a composite bicycle frame and a jig device used in the method

(76) Inventor: Chao-Yao Ko, Taichung Hsien (TW)

Correspondence Address: HARNESS, DICKEY & PIERCE, P.L.C., P.O. BOX 8910, RESTON, VA, 20195, US

(21) Appl. No.: 11/220,671

(22) Filed: Sep. 8, 2005

(51) Int. Cl. B62K 7/00

(52) U.S. Cl. 280/281.1

(57) ABSTRACT

A jig device is provided for supporting an uncured pre-assembled frame part of a composite bicycle frame during the curing of the pre-assembled frame part in a heating chamber. The jig device includes a base plate which has a hanging element to hang the base plate on a support, and a positioning device mounted adjustably on the base plate and adapted to position the pre-assembled frame part on the base plate. A process of making a composite bicycle frame is also disclosed.

### BACKGROUND OF THE INVENTION

1. Field of the Invention

The invention relates to a composite bicycle frame, more particularly to a method of making the composite bicycle frame and a jig device used in the method.

2. Description of the Related Art

FIG. 1 illustrates a conventional jig device for making a composite bicycle frame, wherein metal and composite plastic components of the composite bicycle frame are assembled and adhered to each other by a resin, and are then positioned on the conventional jig device. The jig and the bicycle frame mounted thereon are subsequently sent into a heating chamber for curing to form a unitary frame assembly. The conventional jig device is used for positioning a frame body 1 and a fork body 2 of the composite bicycle frame during the curing process. The frame body 1 includes a triangular frame part 101, an upper rear fork 102 made of a composite plastic material, a lower rear fork 103 made of a composite plastic material, and two rear fork pawls 104 made of metal. The triangular frame part 101 includes a five-way tube 105, a seat tube 106 connected to the five-way tube 105, a head tube 107 confronting the seat tube 106, a top tube 108 connected between the head tube 107 and the seat tube 106, and a down tube 108′ connected between the head tube 107 and the five-way tube 105. The fork body 2 includes a straight tube 201, two prong members 202 each made of a composite plastic material, and two rear fork pawls 203 each made of metal.

The conventional jig device includes a wheeled platform 3, a five-way tube positioning unit 4 mounted on the platform 3, a supporting unit 4′ disposed opposite to the five-way tube positioning unit 4, a head tube positioning unit 5 located to one side of the five-way tube positioning unit 4 and the supporting unit 4′, a first pawl positioning unit 5′ located to the other side of the five-way tube positioning unit 4 and the supporting unit 4′, a tube positioning unit 6 disposed between the five-way tube positioning unit 4 and the supporting unit 4′, an upper rear fork positioning unit 6′ disposed between the supporting unit 4′ and the first pawl positioning unit 5′, a second pawl positioning unit 7 disposed outwardly of the first pawl positioning unit 5′, a tube positioning unit 7′ disposed opposite to the second pawl positioning unit 7, and a prong supporting unit 8 disposed between the second pawl positioning unit 7 and the tube positioning unit 7′.

During assembly, the five-way tube 105 is positioned on the platform 3 through the five-way tube positioning unit 4, the seat tube 106 is pressed and positioned by the tube positioning unit 6 and has one end supported by the supporting unit 4′, the head tube 107 is positioned by the head tube positioning unit 5, the rear fork pawl 104 is positioned by the first pawl positioning unit 5′, the upper rear fork 102 is positioned by the upper rear fork positioning unit 6′, and the fork body 2 is positioned through the second pawl positioning unit 7, the tube positioning unit 7′ and the prong supporting unit 8.

Although the aforementioned conventional jig device can achieve its intended purpose, the platform 3 occupies a substantial space, and must be provided with a plurality of positioning units to permit stable positioning of the frame body 1 and the fork body 2 of the composite bicycle frame and to maintain accurate positional relationship between adjacent components. Furthermore, the structures of the positioning units are complicated, and are difficult to operate. Finally, since the frame body 1 and the fork body 2 are sent to the heating chamber through the platform 3 for curing, the number of the frame assemblies that can be heated within the heating chamber is limited, thereby resulting in a slow process and low productivity.

### SUMMARY OF THE INVENTION

Therefore, an object of the present invention is to provide a method of making a composite bicycle frame by which the number of pre-assembled frame parts of the composite bicycle frame that can be heated and cured in a heating chamber can be increased, thereby increasing the manufacturing productivity of the composite bicycle frame.

Another object of the present invention is to provide a jig device that is used in the method of making a composite bicycle frame, that can be hung, that has a small volume and a simple structure, that is easy to operate, that allows uniform heating of a pre-assembled frame part of the composite bicycle frame that is mounted on the jig device, and that is adjustable so as to precisely position the pre-assembled frame part of the composite bicycle frame on the jig device.

According to one aspect of this invention, a process of making a composite bicycle frame comprises the steps of: positioning an uncured pre-assembled frame part of the composite bicycle frame on a jig which includes a base plate and a positioning device, the pre-assembled frame part including a metal part and a plastic part; conveying the jig along with the pre-assembled frame part into a heating chamber through a conveying device while the base plate is hung on the conveying device; heating and curing the pre-assembled frame part that is hung on the conveying device in the heating chamber so that the pre-assembled frame part forms a unitary body; and cooling the unitary body.

According to another aspect of this invention, a jig device is provided for supporting an uncured composite bicycle frame during the curing of the uncured composite bicycle frame in a heating chamber. The uncured composite bicycle frame includes at least one of an uncured first pre-assembled frame part, and an uncured second pre-assembled frame part. The uncured first pre-assembled frame part includes a triangular frame part made of metal, an upper rear fork made of a composite plastic material, a lower rear fork made of a composite plastic material, and two rear fork pawls made of metal. The triangular frame part includes a five-way tube, a seat tube connected to the five-way tube, a head tube, a down tube connected between the head tube and the five-way tube, and a top tube connected between the head tube and the seat tube. The uncured second pre-assembled frame part includes a front fork which has a front tube made of metal, two prong members made of a composite plastic material and branching from the front tube, and two front fork pawls made of metal. The jig device comprises a jig adapted to support one of the first and second pre-assembled frame parts. The jig includes a base plate which has a hanging element to hang the base plate on a support, and a positioning device associated with the base plate and adapted to position the first or second pre-assembled frame part on the base plate.

According to still another aspect of this invention, a jig device is provided for supporting an uncured pre-assembled frame part of a composite bicycle frame during the curing of the pre-assembled frame part in a heating chamber. The jig device comprises a base plate which has a hanging element to hang the base plate on a support, a positioning device mounted adjustably on the base plate and adapted to position the pre-assembled frame part on the base plate, and an adjustment unit disposed between the base plate and the positioning device to adjust the position of the positioning device on the base plate.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional jig device used in the method of making a composite bicycle frame;

FIG. 2 is a flow chart, illustrating the steps involved in making a composite bicycle frame according to the present invention;

FIG. 3 is a perspective view, illustrating a pre-assembled frame part of the composite bicycle frame positioned on a first jig of a jig device according to the present invention;

FIG. 4 is an exploded perspective view of the first jig of the jig device of the present invention;

FIG. 5 is an assembled schematic view of the first jig;

FIG. 6 is a sectional view taken along line VI-VI of FIG. 3;

FIG. 7 is a sectional view taken along line VII-VII of FIG. 3;

FIG. 8 is a fragmentary schematic view of a tube positioning unit of the jig device shown in FIG. 3;

FIG. 9 is a view similar to FIG. 8, but illustrating the tube positioning unit of the jig device which is moved away from a seat tube;

FIG. 10 is an exploded perspective view of a second jig of the jig device of the present invention; and

FIG. 11 is an assembled sectional view of the second jig in a state of use.

### DETAILED DESCRIPTION OF THE PREFERRED EMBODIMENTS

Before the present invention is described in greater detail, it should be noted that like elements are denoted by the same reference numerals throughout the disclosure.

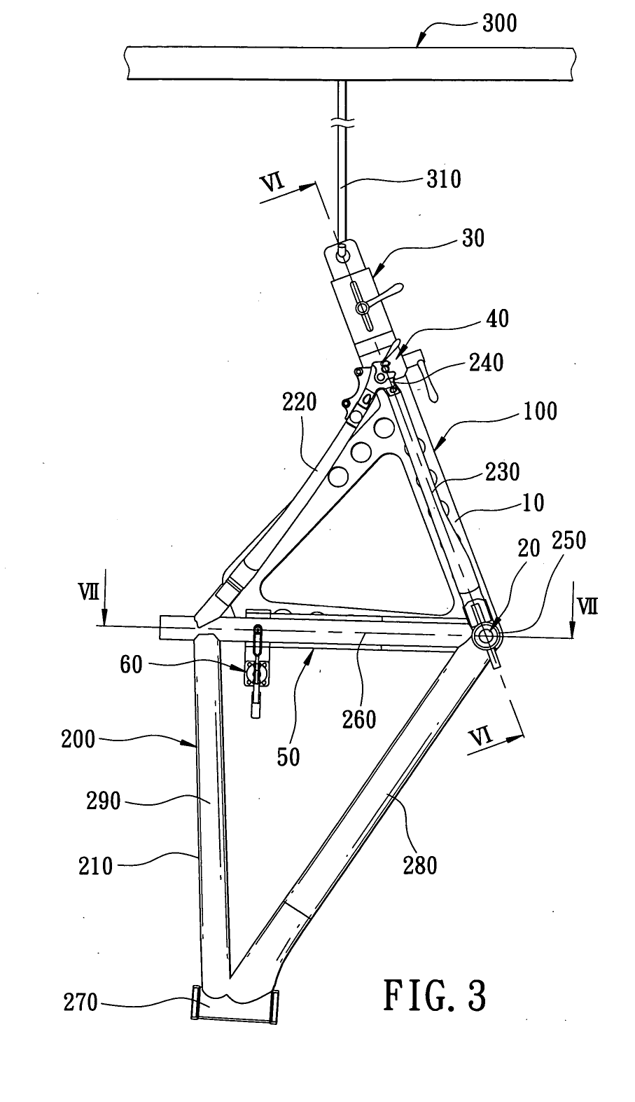

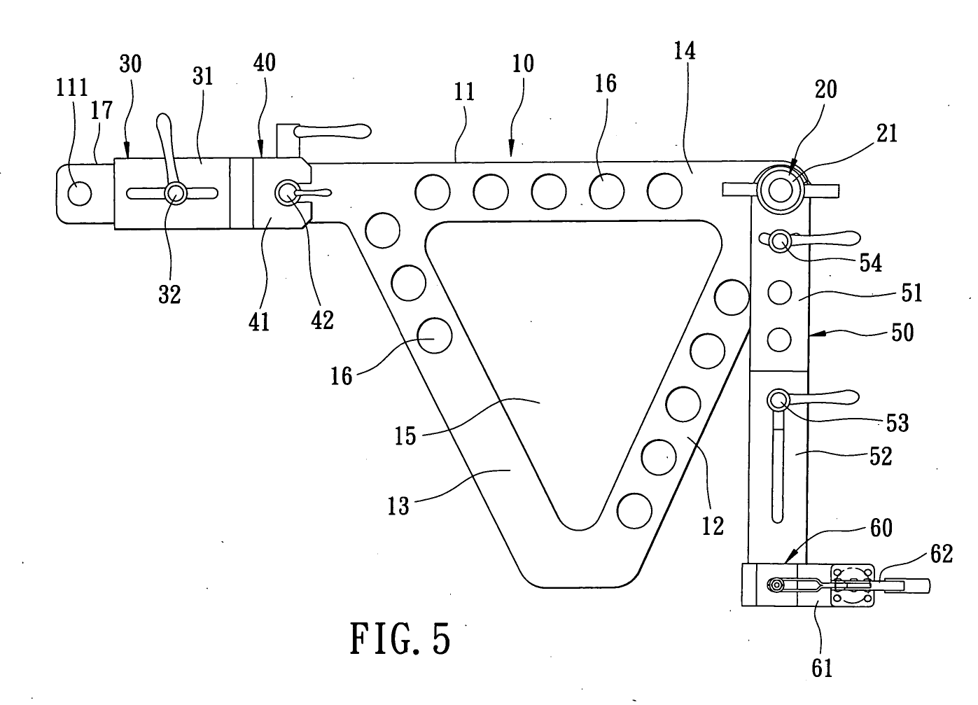

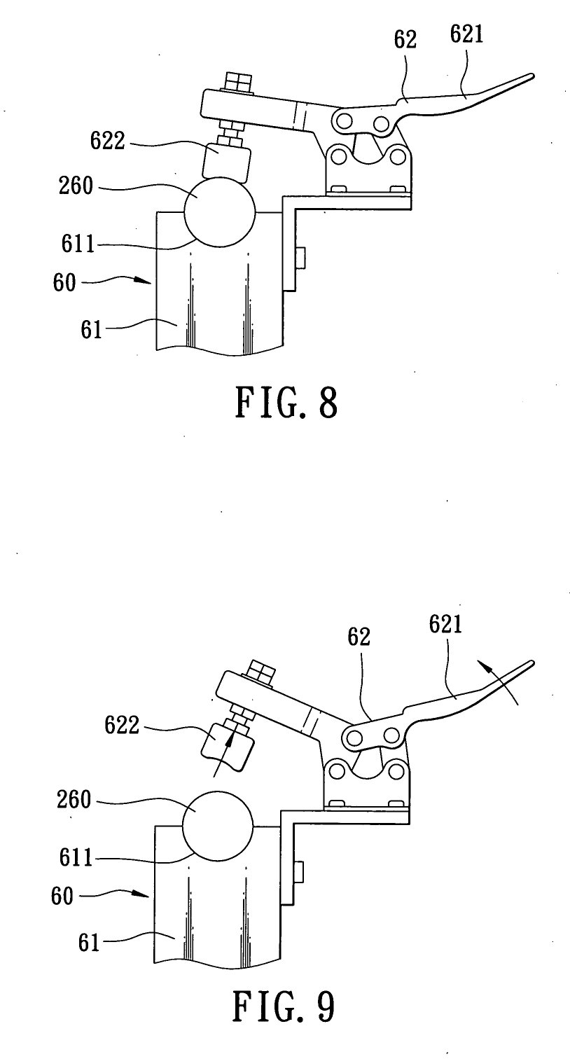

Referring to FIGS. 3 to 9, a jig device according to a preferred embodiment of the present invention includes a first jig 100 which is provided for supporting a first uncured pre-assembled frame part 200 of the composite bicycle frame during the curing of the first uncured pre-assembled frame part 200 in a heating chamber (not shown). The first uncured pre-assembled frame part 200 includes a triangular frame part 210 made of metal, an upper rear fork 220 made of a composite plastic material, a lower rear fork 230 made of a composite plastic material, and two rear fork pawls 240 made of metal. The triangular frame part 210 includes a five-way tube 250, a seat tube 260 connected to the five-way tube 250, a head tube 270 opposite to the seat tube 260, a down tube 280 connected between the head tube 270 and the five-way tube 250, and a top tube 290 connected between the head tube 270 and the seat tube 260.

The first jig 100 includes a base plate 10 and a positioning device. The positioning device includes a five-way tube positioning unit 20, an adjustment unit (30, 50), a pawl positioning unit 40, and a tube positioning unit 60.

The base plate 10 includes a substantially triangular loop part composed of interconnected first, second and third bars 11, 12, 13, and an extension part 17 extending outwardly from the first bar 11. The extension part 17 has a hanging element in the form of a hanging hole 111. The first to third bars 11, 12, 13 cooperatively define a triangular cutout portion 15. Each of the first to third bars 11, 12, 13 is provided with a plurality of through holes 16 to reduce the weight of the base plate 10 and to allow air to ventilate through the base plate 10.

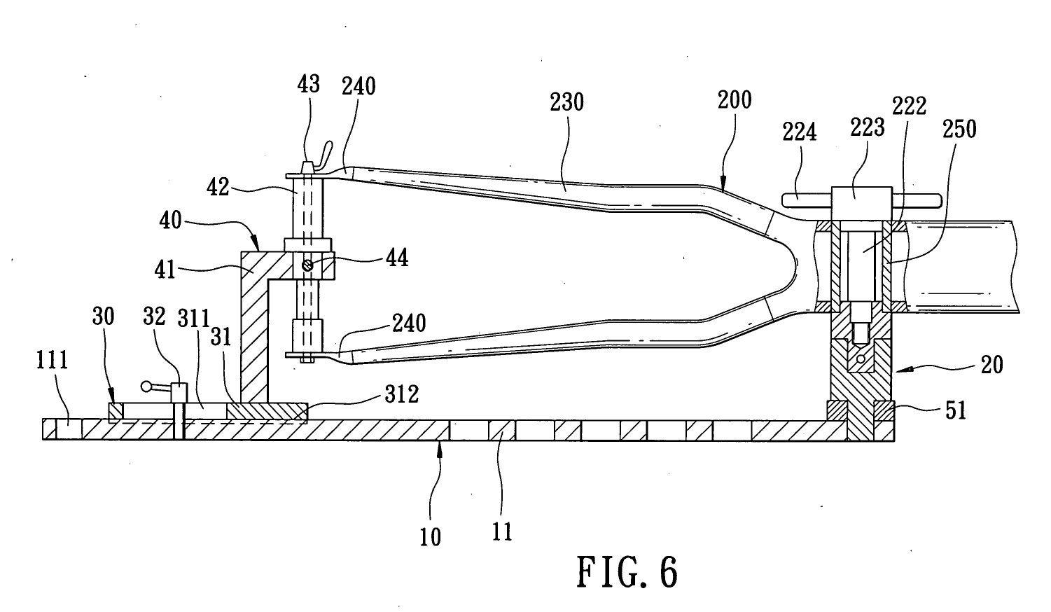

The five-way tube positioning unit 20 includes a positioning member 21 connected to the base plate 10 in a perpendicular manner and adapted to support the five-way tube 250 on the first jig 100, and a connecting member 22 adapted to fix the five-way tube 250 to the positioning member 21. The positioning member 21 is cylindrical, and has a screw hole 211 formed therein. The connecting member 22 has a shank portion 222, a screw portion 221 extending downwardly from a bottom end of the shank portion 222 to engage the screw hole 211, and a head portion 223 connected to a top end of the shank portion 222 and provided with a lever 224. The five-way tube 250 is secured to the five-way tube positioning unit 20 by turning the lever 224 of the head portion 223, as best shown in FIG. 6.

The adjustment unit includes a slidable adjusting unit 30 and a rotary plate unit 50. The slidable adjusting unit 30 is disposed on one side of the five-way tube positioning unit 20, and has a slide plate 31 fastened slidably to the extension part 17 of the base plate 10 through a first fastening member 32. The slide plate 31 includes a slide slot 311 extending along the length of the extension part 17, and a groove 312 formed in a bottom face of the slide plate 31. The slide plate 31 is engaged slidably with the extension part 17 through the groove 312. The first fastening member 32 passes through the slide slot 311, and engages the extension part 17 so as to fix releasably and adjustably the slide plate 31 to the extension part 17.

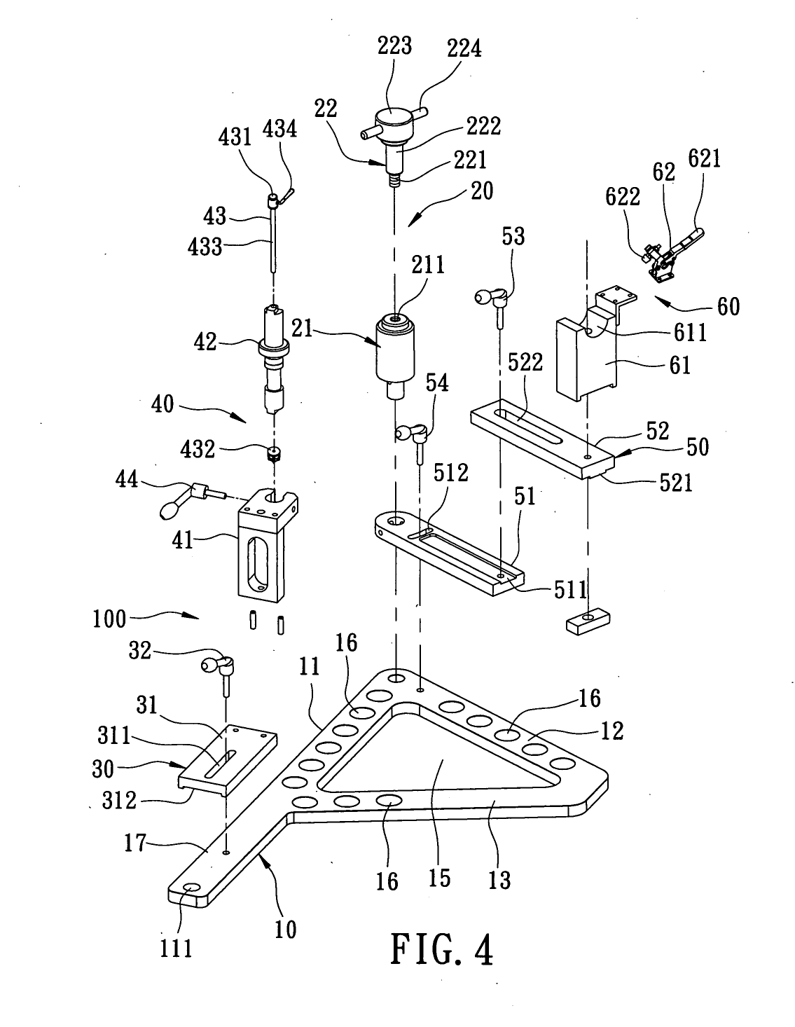

The rotary plate unit 50 is mounted pivotally on the second bar 12 of the base plate 10, and is disposed between the base plate 10 and the five-way tube positioning unit 20. As best shown in FIGS. 4, 6 and 7, the rotary plate unit 50 includes a rotatable plate 51 mounted between the positioning member 21 and the base plate 10 and rotatable relative to the base plate 10, an extension plate 52 connected telescopically to the rotatable plate 51, a second fastening member 53 to fix releasably the extension plate 52 to the rotatable plate 51, and a third fastening member 54 to fix releasably the rotatable plate 51 to the second bar 12 of the base plate 10. The rotatable plate 51 has a slide groove 511 formed in a top face thereof and extending along the length of the rotatable plate 51, and a curve slot 512 formed on one side of the engaging groove 511 for extension of the third fastening member 54 therethrough. The extension plate 52 has an engaging portion 521 provided on a bottom portion thereof to engage slidably the slide groove 511, and an elongated guide hole 522 extending along the length of the extension plate 52 for passing of the second fastening member 53 therethrough.

As best shown in FIGS. 4 and 6, the pawl positioning unit 40 is fastened on top of the slidable adjusting unit 30, and includes a fixed member 41 connected to the slide plate 31, a rod member 42 inserted into the fixed member 41, a set of fasteners adapted to position the rear fork pawls 240 on two opposite ends of the rod member 42, respectively, and a locking member 44 to lock tightly the rod member 42 to the fixed member 41. In this embodiment, the set of fasteners includes a pin 43 having a head portion 431 and a shank portion 433 connected to the head portion 431, and a nut member 432 attached to the shank portion 433. A lever 434 is provided on the head portion 431 of the pin 43, and is operated to move the head portion 431 towards or away from the nut member 432.

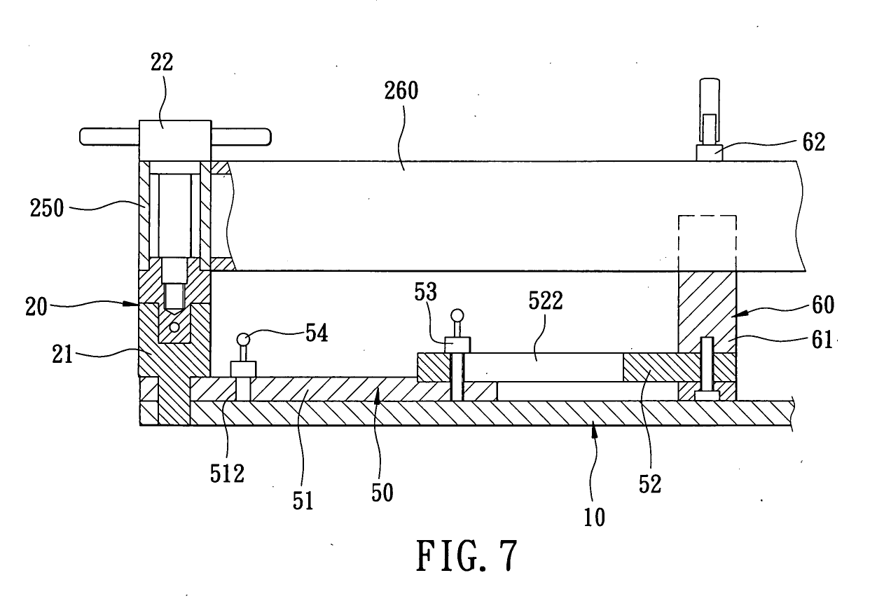

As best shown in FIGS. 7, 8 and 9, the tube positioning unit 60 is disposed on the rotary plate unit 50, and includes a supporting member 61 connected to the extension plate 52 and adapted to support the seat tube 260 on the base plate 10, and a press member 62 connected to the supporting member 61 and adapted to press the seat tube 260 against the supporting member 61. The supporting member 61 has a notch 611 formed in a top portion thereof. The press member 62 has a lever 621, and a press piece 622 that is movable toward or away from the notch 611 through operation of the lever 621 to press or release the seat tube 260.

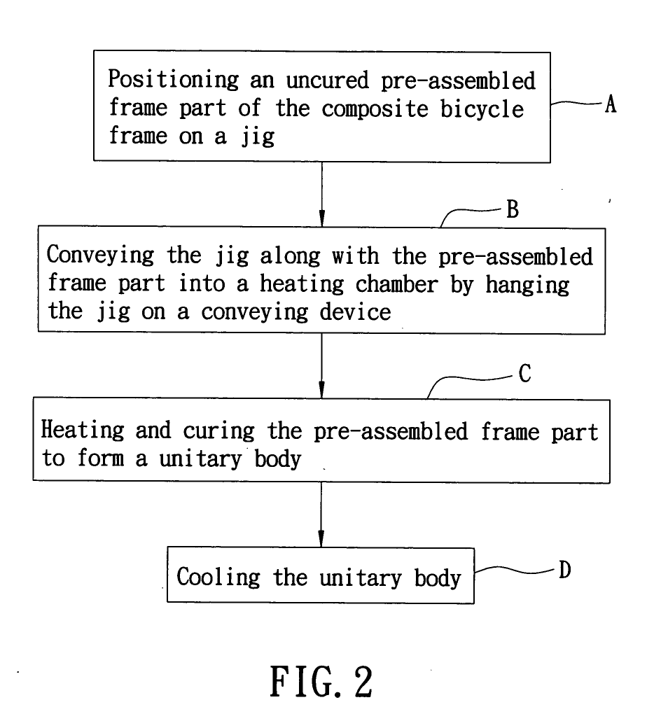

A preferred embodiment of a method for making a composite bicycle frame according to the present invention is illustrated in FIG. 2. In the method, the composite bicycle frame is made by heating and curing an uncured pre-assembled frame part of the composite bicycle frame.

The pre-assembled frame part may be the first uncured pre-assembled frame part 200 which includes the triangular frame part 210, the upper rear fork 220, the lower rear fork 230, and the rear fork pawls 240. In step (A), the first uncured pre-assembled frame part 200 is positioned on the first jig 100. In particular, the five-way tube 250 is positioned through the five-way tube positioning unit 20, and the slidable adjusting unit 30 is slid relative to the extension part 17 so that the pawl positioning unit 40 is aligned properly with the rear fork pawls 240. By turning the rotatable plate 51 and by sliding the extension plate 52 relative to the rotatable plate 51, the tube positioning unit 60 can be aligned properly with the seat tube 260. As such, the first uncured pre-assembled frame part 200 can be stably positioned on the base plate 10, and the distance between the five-way tube 250 and the rear fork pawls 240 can be accurately controlled.

In step (B), after the first uncured pre-assembled frame part 200 is positioned on the first jig 100, the first jig 100 is hung on a hook 310 of a conveying device 300 through the hanging hole 111. Through the conveying device 300, the first jig 100 together with the first uncured pre-assembled frame part 200 are sent to a heating chamber (not shown).

In step (C), the first uncured pre-assembled frame part 200 is heated in the heating chamber so that the first uncured pre-assembled frame part 200 is cured and formed into a unitary body. In step (D), the unitary body is cooled after the first jig 100 together with the first uncured pre-assembled frame part 200 are removed from the heating chamber.

The advantages of using the method and the jig device of the present invention are summarized as follows:

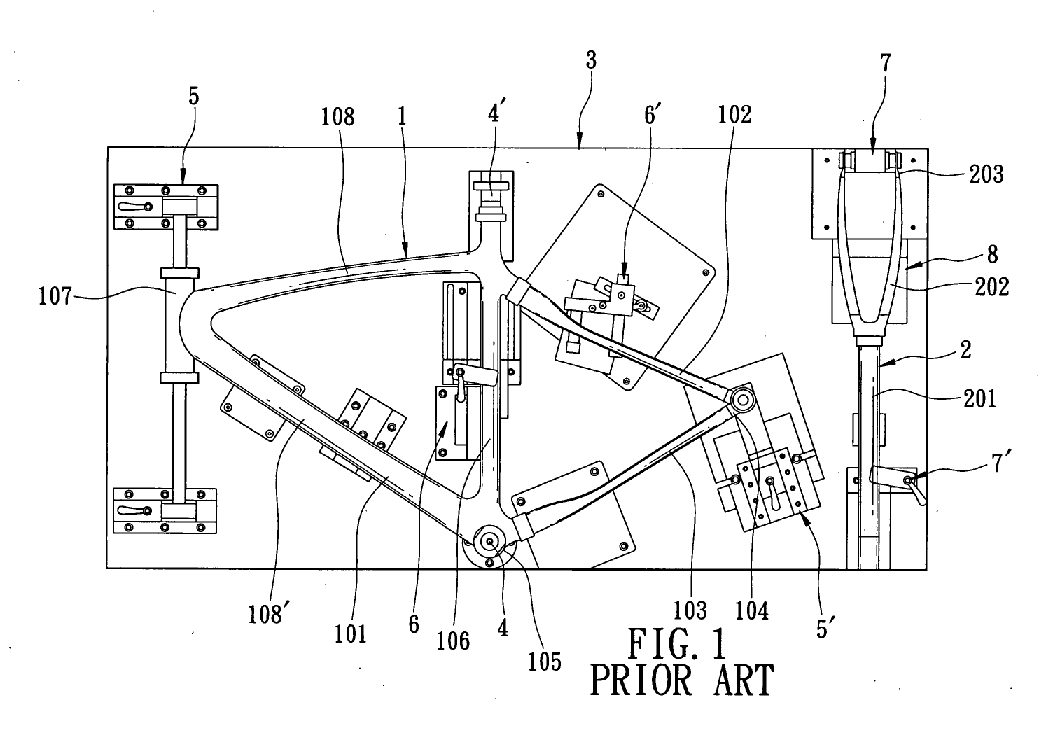

1. Since the base plate 10 of the first jig 100 is small and lightweight, and since the first jig 100 is hung vertically on the hook 310 of the conveying device 300, the heating chamber can accommodate a larger number of pre-assembled frame parts to be cured. The present invention thus increases the production rate of the bicycle frame compared to the conventional jig device of FIG. 1.

2. Due to the provision of the slidable adjusting unit 30 and the rotary plate unit 50, adjustment of the positioning device can be easily performed. In particular, the slidable movement of the slide plate 31 relative to the extension part 17 permits adjustment of the pawl positioning unit 40 relative to the five-way tube positioning unit 20. The rotatable movement of the rotatable plate 51 relative to the base plate 10, and the sliding movement of the extension plate 52 permit adjustment of the position of the tube positioning unit 60. Therefore, the first jig 100 is suitable for use with the uncured pre-assembled frame parts of different sizes. In addition, since the first uncured pre-assembled frame part 200 can be stably and properly positioned on the base plate 10, the resulting size of the first uncured pre-assembled frame part 200 may be controlled easily and precisely.

3. By hanging the first jig 100 with the first uncured pre-assembled frame part on the conveying device 300 and by conveying the same into the heating chamber, and through the presence of the cutout portion 15 and the through holes 16 in the base plate 10, the first uncured pre-assembled frame part 200 can be heated uniformly.

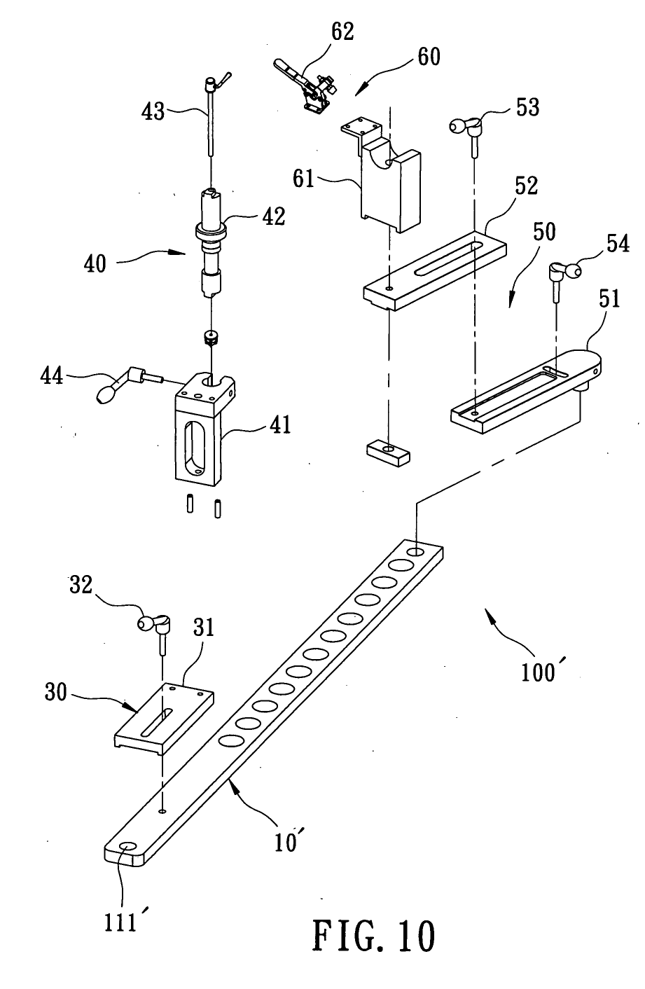

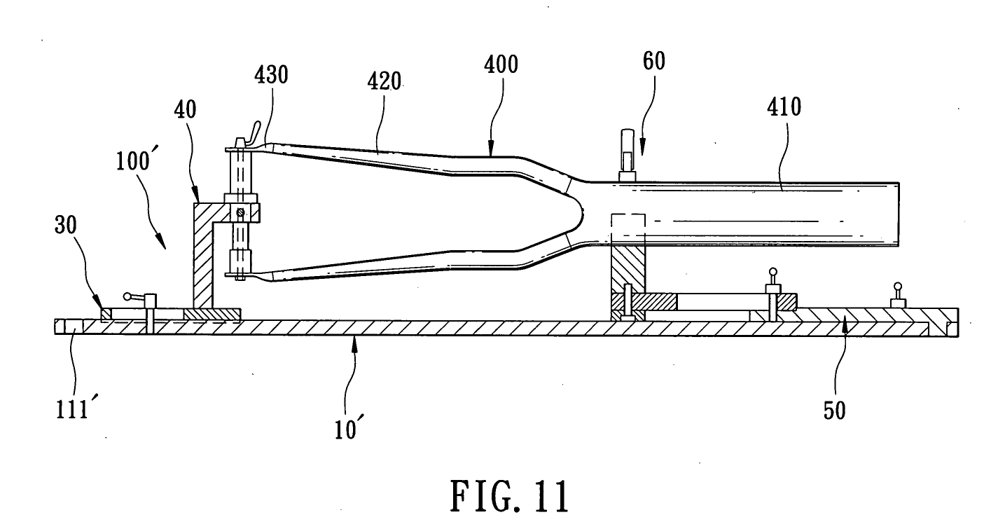

Referring to FIGS. 10 and 11, there is shown a second jig 100′ for supporting a second uncured pre-assembled frame part 400 of the composite bicycle frame during the curing of the second uncured pre-assembled frame part 400 in a heating chamber. The second uncured pre-assembled frame part 400 includes a front fork which has a front tube 410 made of metal and two prong members 420 branching from the front tube 410 and made of a composite plastic material, and two front fork pawls 430 made of metal.

The second jig 100′ includes a base plate 10′ and a positioning device. The positioning device includes slidable adjusting unit 30, a pawl positioning unit 40 fastened on top of the slidable adjusting unit 30, a rotary plate unit 50 mounted on the base plate 10′ and disposed distal from the slidable adjusting unit 30, and a tube positioning unit 60 fastened on top of the rotary plate unit 50. The base plate 10′, in this embodiment, is configured as an elongated bar, and has a hanging element in the form of a hanging hole 111′ formed in one end of the bar. The front fork pawls 430 are positioned on the second jig 100′ through the pawl positioning unit 40, and the front tube 410 is positioned through the tube positioning unit 60. When the second uncured pre-assembled frame part 400 is mounted on the second jig 100′, the effect obtained is similar to that when using the first jig 100.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A process of making a composite bicycle frame, comprising:
(A) positioning an uncured pre-assembled frame part of the composite bicycle frame on a jig which includes a base plate and a positioning device, said pre-assembled frame part including a metal part and a plastic part;
(B) conveying said jig along with said pre-assembled frame part into a heating chamber through a conveying device while said base plate is hung on said conveying device;
(C) heating and curing said pre-assembled frame part that is hung on said conveying device in said heating chamber so that said pre-assembled frame part forms a unitary body; and
(D) cooling said unitary body.

2. The method of claim 1, wherein said jig is hung by attaching one end portion of said jig to said conveying device in step (B).

3. The method of claim 1, wherein
said uncured pre-assembled frame part includes a triangular frame part made of metal, an upper rear fork made of a composite plastic material, a lower rear fork made of a composite plastic material, and two rear fork pawls made of metal, said triangular frame part including a five-way tube, a seat tube connected to said five-way tube, a head tube, a down tube connected between said head tube and said five-way tube, and a top tube connected between said head tube and said seat tube, and said five-way tube, said seat tube and said rear fork pawls are fastened to said base plate using said positioning device.

4. The method of claim 3, wherein said base plate includes a substantially triangular loop part composed of three bars interconnected to form substantially a triangle, and an extension part extending outwardly from one of said bars.

5. The method of claim 1, wherein said uncured pre-assembled frame part includes a front fork which has a front tube made of metal and two prong members branching from said front tube and made of a composite plastic material, and two front fork pawls made of metal.

6. The method of claim 5, wherein said base plate includes a bar, said positioning device being used to fasten said front fork pawls and said front tube to said bar.

7. A jig device for supporting an uncured composite bicycle frame during the curing of the uncured composite bicycle frame in a heating chamber, the uncured composite bicycle frame including at least one of an uncured first pre-assembled frame part and an uncured second pre-assembled frame part, the uncured first pre-assembled frame part including a triangular frame part made of metal, an upper rear fork made of a composite plastic material, a lower rear fork made of a composite plastic material, and two rear fork pawls made of metal, said triangular frame part including a five-way tube, a seat tube connected to said five-way tube, a head tube, a down tube connected between said head tube and said five-way tube, and a top tube connected between said head tube and said seat tube, the uncured second pre-assembled frame part including a front fork which has a front tube made of metal, two prong members made of a composite plastic material and branching from the front tube, and two front fork pawls made of metal, said jig device comprising:
a jig adapted to support one of the first and second pre-assembled frame parts, said jig including a base plate which has a hanging element to hang said base plate on a support, and a positioning device associated with said base plate and adapted to position the first or second pre-assembled frame part on said base plate.

8. A jig device of claim 7, wherein said base plate includes a substantially triangular loop part composed of three bars interconnected to form substantially a triangle, and an extension part extending outwardly from one of said bars, said hanging element being formed as a hanging hole in said extension part, said positioning device being adapted to position the first pre-assembled frame part on said base plate.

9. The jig device of claim 8, wherein said positioning device includes:
a five-way tube positioning unit adapted to position said five-way tube on said loop part;
a pawl positioning unit adapted to position said rear fork pawls on said loop part; and
a tube positioning unit adapted to position said seat tube on said loop part.

10. The jig device of claim 9, wherein
said five-way tube positioning unit includes a positioning member connected to said base plate in a perpendicular manner and adapted to support said five-way tube, and a connecting member adapted to fix said five-way tube to said positioning member,
said pawl positioning unit includes a fixed member connected to said base plate, a rod member inserted into said fixed member, a set of fasteners adapted to position said rear fork pawls on two opposite ends of said rod member, respectively, and
said tube positioning unit includes a supporting member mounted on said base plate and adapted to support said seat tube, and a press member connected to said supporting member and adapted to press said seat tube against said supporting member.

11. The jig device of claim 10, further comprising a slide plate connected slidably to said base plate, and a first fastening member for fixing releasably said slide plate to said base plate, said pawl positioning unit being attached to said slide plate.

12. The jig device of claim 10, further comprising a rotary plate unit mounted between said tube positioning unit and said base plate, said rotary plate unit including a rotatable plate connected to said positioning member of said five-way tube positioning unit and mounted pivotally on said base plate, an extension plate connected telescopically to said rotatable plate, and a second fastening member for fixing releasably said extension plate on said rotatable plate, said tube positioning unit having said supporting member positioned on said extension plate.

13. The jig device of claim 12, wherein said rotary plate unit further includes a curve slot formed in said rotatable plate, and a third fastening member extending through said curve slot and fixing releasably said rotatable plate to said base plate.

14. The jig device of claim 7, wherein said base plate includes a bar, said hanging element being formed as a hanging hole in one end of said bar, said positioning device being adapted to position the second pre-assembled frame part on said bar.

15. The jig device of claim 14, wherein said positioning device comprises:
a pawl positioning unit adapted to position the front fork pawls on said bar; and
a tube positioning unit adapted to position the front tube on said bar.

16. A jig device for supporting an uncured pre-assembled frame part of a composite bicycle frame during the curing of the pre-assembled frame part in a heating chamber, said jig device comprising:
a base plate which has a hanging element to hang said base plate on a support;
a positioning device mounted adjustably on said base plate and adapted to position the pre-assembled frame part on said base plate; and
an adjustment unit disposed between said base plate and said positioning device to adjust the position of said positioning device on said base plate.

17. The jig device of claim 16, wherein said adjustment unit includes a slidable adjusting unit having a slide plate mounted slidably on said base plate, said positioning device being attached to said slide plate.

18. The jig device of claim 17, wherein said slide plate includes a slide hole, and a first fastening member extending through said slide hole and fixing releasably said slide plate to said base plate.

19. The jig device of claim 16, wherein said adjustment unit includes a rotary plate unit mounted pivotally on said base plate, said positioning device being attached to said rotatable plate unit.

20. The jig device of claim 19, wherein said rotary plate unit includes a rotatable plate pivoted to said base plate, an extension plate connected telescopically to said rotatable plate, a second fastening member to fix releasably said extension plate to said rotatable plate, a curve slot provided in said rotatable plate, and a third fastening member extending through said curve slot and fixing releasably said rotatable plate to said base plate, said positioning device being attached to said extension plate.
